(19) United States
(12) Patent Application Publication
(10) Pub. No.: US 2005/0266829 A1
(43) Pub. Date: Dec. 1, 2005

(54) Speech-to-text messaging system and method

(75) Inventors: Luc Phu Tran, Escondido, CA (US); Nam Sung Cho, San Diego, CA (US); Heung Yeoul Ahn, San Diego, CA (US)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Elcectronics, Inc.

(21) Appl. No.: 10/826,247

(22) Filed: Apr. 16, 2004

(51) Int. Cl. H04M 11/10

(52) U.S. Cl. 455/412.1; 455/413

(57) ABSTRACT

A method of communicating data in a mobile communications network is provided. The method comprises recording a voice message for delivery from an initiating device to a terminating device, wherein the initiating device and terminating device are configured to communicate over the mobile communications network; converting the recorded voice message to a text message using a speech-to-text conversion process; and delivering the text message to the terminating device by way of a text messaging service implemented over the mobile communications network for delivering text messages from the initiating device to the terminating device.

### BACKGROUND

1. Field of the Invention

This invention generally relates to voice and text messaging services in digital wireless mobile communication systems. In particular, the present invention relates to a feature for allowing a mobile user to view voicemail in the form of text instead of listening to it.

2. Description of the Related Art

In a mobile communications network, if a mobile service subscriber does not answer a voice call, the caller has the option of leaving a voice message. To notify the subscriber of a voice message, typically, a graphic display, a tone alert or both are generated by the subscriber's mobile device.

Unfortunately, the above alert mechanisms do not provide the subscriber with information about the content of the voice message. Certain systems provide a caller identification feature that identifies the identity or the telephone number of a caller. This feature, however, also does not provide content information to the subscriber in real-time.

In a dynamic and fast paced working environment, a subscriber may require access to the content of a voice message in real-time or as soon as possible after the voice message is available. For example, if a subscriber is in a meeting, answering a call or listening to voicemail may be rude or socially unacceptable. Nevertheless, the subscriber may want to know the content of the message.

Therefore, a system and method is needed that can overcome the shortcomings of the current messaging models.

### SUMMARY OF THE INVENTION

These and other embodiments of the present invention will also become readily apparent to those skilled in the art from the following detailed description of the embodiments having reference to the attached figures, the invention not being limited to any particular embodiments disclosed.

In accordance with one or more embodiments, a method of communicating data in a mobile communications network is provided. The method comprises recording a voice message for delivery from an initiating device to a terminating device, wherein the initiating device and terminating device are configured to communicate over the mobile communications network; converting the recorded voice message to a text message using a speech-to-text conversion process; and delivering the text message to the terminating device by way of a text messaging service implemented over the mobile communications network for delivering text messages from the initiating device to the terminating device.

In one embodiment, the speech-to-text conversion process resides in the initiating device to convert the voice message to the text message. In another embodiment, the speech-to-text conversion process resides in the mobile communications network to convert the voice message to the text message.

In one embodiment, the text messaging service is a short messaging service (SMS), an extended messaging service (EMS) or multi-media messaging service (MMS). A message mode is defined to indicate that the voice message should be converted to a text message in one embodiment. A party using the initiating device, or the terminating device may set the message mode. In one embodiment, the recorded voice message is deleted after the text messaged is delivered to the terminating device.

In accordance with another embodiment, a method of communicating data in a mobile communications network is provided. The method comprises recording a voice message for delivery from an initiating device to a terminating device, wherein the initiating device and the terminating device are configured to communicate over the mobile communications network; delivering the voice message to the terminating device over the mobile communications network; and converting the recorded voice message to a text message using a speech-to-text conversion process residing on the terminating device. The text message is displayed on the terminating device.

In one embodiment, the text message is delivered from the terminating device to the terminating device using a text messaging service. The text messaging service may be a short messaging service (SMS), an extended messaging service (EMS) or a multi-media messaging service (MMS).

In one embodiment of the invention, a communications device comprises means for interfacing with a voice recording mechanism to record a voice message for transmission to a first mobile device connected to a mobile communications network; and means for choosing for the voice message to be converted to a text message via a speech-to-text conversion process, wherein the text message is delivered to the first mobile device by way of a text messaging service implemented over the mobile communications network.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention, and together with the description, serve to explain the principles of the invention.

FIG. 1 is a block diagram illustrating the system architecture for the speech-to-text conversion mechanism of the invention, in one embodiment.

FIG. 2 is a flow diagram illustrating the speech-to-text conversion method of the invention, in accordance with one embodiment.

FIG. 3 illustrates a point-to-point text messaging connection established between originating and terminating mobile devices, in one embodiment.

FIG. 4 illustrates an exemplary messaging method in accordance with one embodiment of the invention, wherein a voice mail message is delivered to a mobile device.

FIG. 5 illustrates the various components of an exemplary mobile station or mobile terminal 500, in accordance with one embodiment of the invention.

Features, elements, and aspects of the invention that are referenced by the same numerals in different figures represent the same, equivalent, or similar features, elements, or aspects in accordance with one or more embodiments.

### DETAILED DESCRIPTION OF THE PREFERRED EMBODIMENTS

In accordance with one embodiment of the invention, a speech-to-text messaging system and method is implemented to convert the content of a voice message for a particular subscriber into text and to transmit the text to the subscriber.

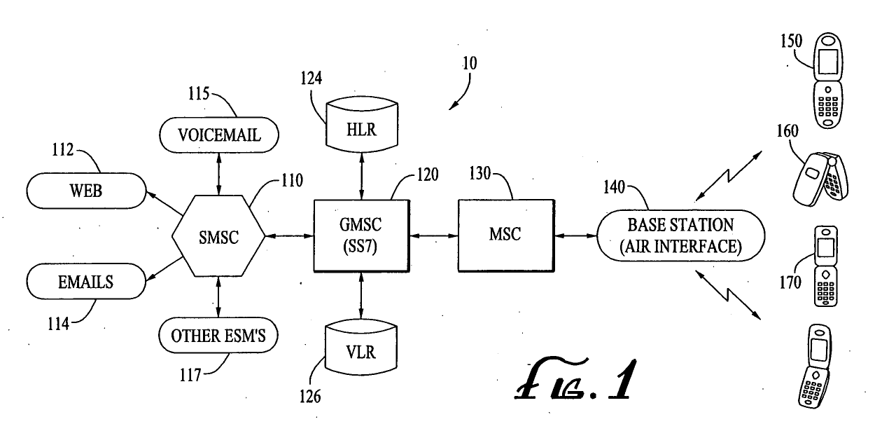

Referring to FIG. 1, a system 10 according to the preferred embodiment invention may comprise a short message service center (SMSC) 110, for example. The SMSC 110 comprises hardware and software infrastructure for storing and forwarding text messages and particularly short text messages. The SMSC 110 storage and forwarding infrastructures make it possible for a mobile subscriber to receive a message even if the subscriber's mobile device is out of service, out of range, or switched off.

The system further comprises a SMS—gateway mobile switching center (SMS—GMSC) 120 for delivering short messages to a particular subscriber by interrogating a home location register (HLR) 124 and/or visitor location register (VLR) 126 to determine routing information for delivering a message.

HLR 124 comprises a permanent storage and the infrastructure for management of subscriptions and service profiles. For example, HLR may contain a subscriber's status and location, or routing information on how to access the subscriber or the subscriber's profile.

In a preferred embodiment, HLR 124 comprises a database in a cellular communications network, wherein the database contains all the subscribers within the provider's home service area. When a subscriber reaches a new service area, the data in HLR 124 is requested and transferred to VLR 126 in the new area.

VLR 126 comprises temporary profiles for visiting (i.e., roaming) subscribers. The temporary profiles are used when a subscriber is not within a home HLR 124, for example. In addition, VLR 126 provides the routing information to ensure that the appropriate subscriber receives the respective calls or messages. In a preferred embodiment, for example, VLR 126 comprises a list of all the subscribers that are currently visiting within the service area

In one embodiment, mobile switching center (MSC) 130 provides switching and routing services for the communications network illustrated in FIG. 1. MSC 130 manages multiple tasks such as registration, authentication, location updating, handovers and routing to roaming subscribers, for example. A plurality of base stations (BS) 140 provides a communications interface between MSC 130 and mobile devices 150 to establish and maintain voice and data traffic as a mobile device moves within the network.

An extended messaging service (EMS) or a multi-media messaging service (MMS) may also be implemented to communicate data over the communications network of FIG. 1. EMS service may be utilized to send text, ring-tones, operator logos and other simple visual messages to EMS capable handsets. MMS may be used to send messages comprising a combination of text, sounds, images and video to MMS capable handsets. Accordingly, in the preferred embodiment of the invention, a voice message once received by SMSC 110 is converted to a text message and is forwarded to a target subscriber via SMS, EMS or MMS as provided in further detail below.

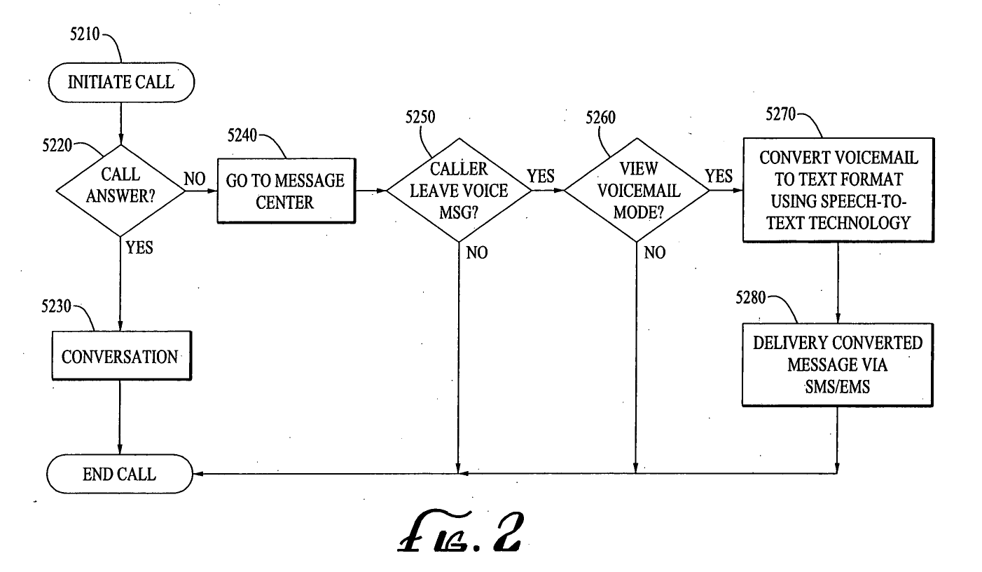

Referring to FIG. 2, in accordance with the preferred embodiment, when a caller initiates a call to a subscriber (S210), the call is routed to the subscriber's mobile device 150 through the infrastructure of the communications network illustrated in FIG. 1, for example. If the call is answered (S220) then a voice connection is established and the subscriber will be able to carry on a conversation with the caller (S230).

Otherwise, if the call is not answered (i.e., if mobile device 150 is turned off, or if it is in no answer mode, or if the subscriber does not pickup, etc.) then the call is transferred to a voice mail message center 115 (S240). If the caller wishes, the caller may leave a voice message (S250) otherwise the call is disconnected.

According to another embodiment, if the caller leaves a voice message, then the system determines if the mobile device is in view voice mail mode (S260). That is, the system determines if a configuration has been set to indicate that the subscriber prefers to view recorded voice messages in textual form. If so, then the system converts the voice message to text format using a speech-to-text technology (S270).

According to one embodiment,. a speech-to-text conversion engine or process, depending on implementation, may reside either in mobile device 150 or alternatively in a component of the communications network responsible for delivery of the voice message. For example, a speech-to-text conversion engine may reside in SMSC 110, an application development environment for wireless servers (e.g., BREW), a MMS provider, or other wireless service or content providers.

As such, in the embodiments of the invention, where the speech-to-text conversion engine is installed on the mobile device 150, a voice message is communicated to the mobile device 150, where the mobile device 150 is at the terminating end of the communication. If the mobile device 150 is not available (i.e., turned off), then voice data is transmitted to it after it has been turned on. Once the mobile device 150 receives the voice message, then the speech-to-text engine in the mobile device 150 converts the content of the voice message to text and stores the text for display on the mobile device 150. Accordingly, the user is then notified by way of an alert (e.g., audio or graphic) that a text message is pending.

In another embodiment, the speech-to-text conversion engine is utilized prior to the transmission of the voice message from mobile device 150 to MSC 130. That is, the voice message is converted by the speech-to-text engine residing in the originating mobile device, instead of the speech-to-text engine residing in the terminating mobile device. In this embodiment, text data is forwarded to the corresponding MCS 130, which then transmits the text data to the terminating mobile device by way of a short messaging service or other text messaging mechanism. In some embodiments, a sender may determine whether he would like to deliver the message as a voice mail or a text message by, for example, selecting a menu option.

Alternatively, in the embodiment of the invention where the speech-to-text conversion engine is installed on the network, a voice message is converted to text as soon as the voice message is received. The text and voice messages are stored on a storage device, for example, connected to the network. This storage device may reside in a network component illustrated in FIG. 1, or alternatively in mobile device 150. Once the messages are stored, an alert is communicated to mobile device 150. As such, the subscriber may then choose to view the stored text message or alternatively may choose to hear the stored voice message, or both.

In one embodiment of the invention, a subscriber may configure system settings such that a voice message is removed from storage if it is converted to a text message. Other settings may allow the subscriber to configure the system to edit, store, delete, forward, or otherwise manipulate the text messages received or converted. Various applications and tools may be implemented or utilized, in one or more embodiments of the invention, to configure, display, or transmit a text message, for example.

In certain embodiments, after a voice mail message is converted to textual format, SMS, EMS or MMS services can be used to deliver the text message to the ultimate destination. As such, one or more content delivery engines or applications may be configured to interact with the speech-to-text conversion engine of the system to communicate and display the message content to a subscriber.

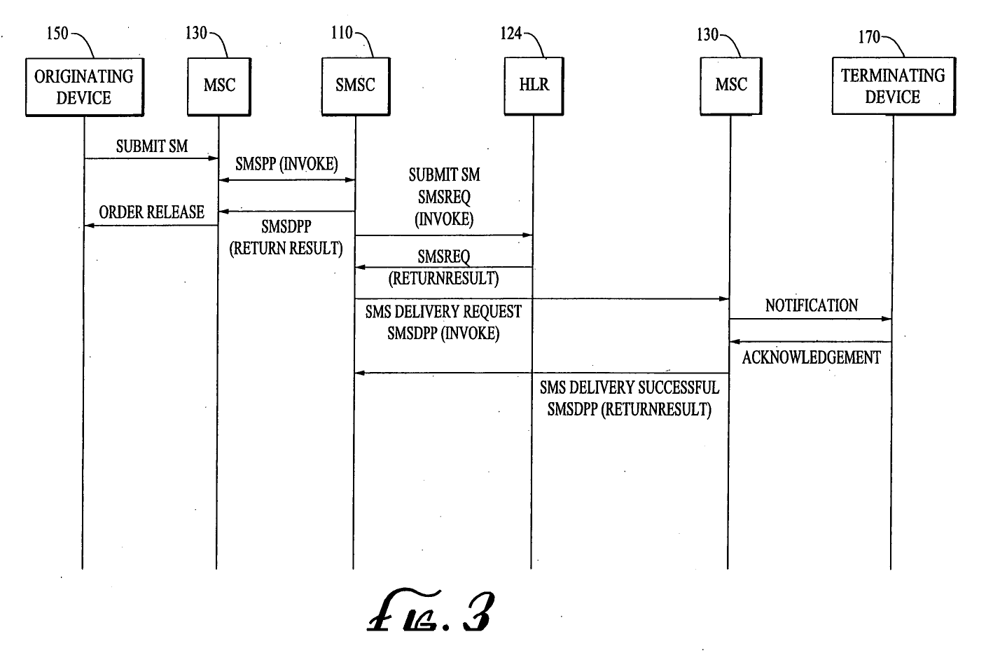

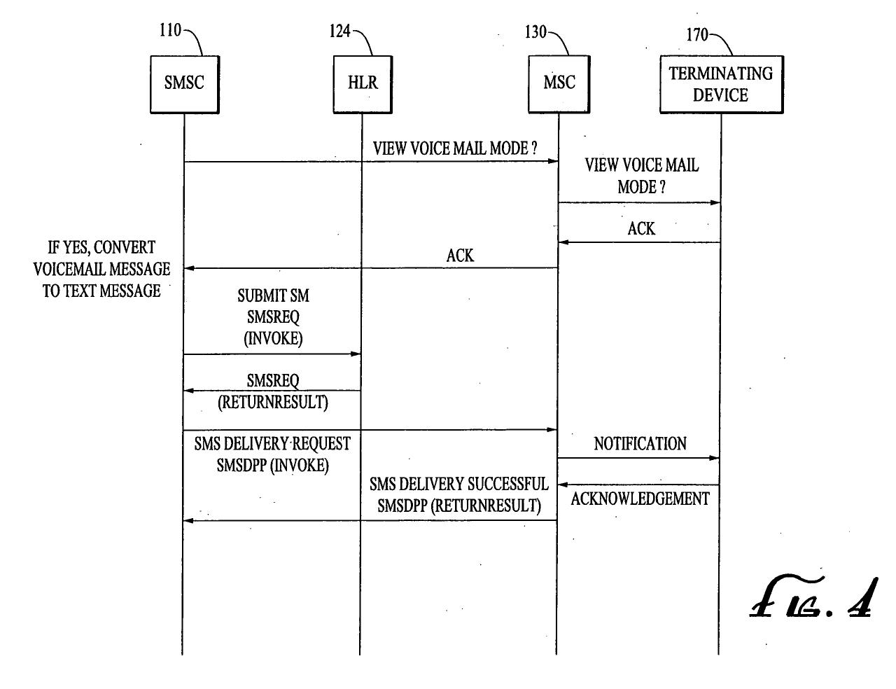

Referring to FIGS. 3 and 4, one or more embodiments of the invention are described as applicable to an SMS delivery service. It should be noted, however, that such application is by way of example, and as such should not be construed as limiting the scope of the invention to the particular delivery service. Other implementations and mechanisms for delivery and communication of information may be utilized to achieve the same results without detracting from the functionality or utility of the invention.

As shown in FIG. 3 and referring back to FIG. 1, in an exemplary embodiment, an originating device 160 may initiate a phone call or transmission of a short message by submitting a request to a corresponding MSC 130. MSC 130 in turn invokes a voice or messaging protocol (e.g., short message service protocol (SMS)) directed to SMSC 110. SMSC 110 interrogates HLR 124 (or VLR 126) to determine the routing information for the call or the message. Results of the interrogation are returned to SMSC 110 from HLR 124.

If routing data for the terminating device (i.e., destination device) is available, then a delivery request is submitted from SMSC 110 to MSC 130. The delivery request, for example, may identify terminating device 170 as the destination for delivery of the message. If so, then MSC 130 transmits a notification message to terminating device 170 indicating that a voice call or a short message is pending. Terminating device 170 then responds by way of sending an acknowledgement to MSC 130. MSC 130 provides the response to SMSC 110 confirming a successful voice connection or successful delivery of the message.

When a voice connection is not successfully established, then a voice mail message may be recorded for delivery to terminating device 170. Terminating device 170 may be configured in accordance with one embodiment of the invention so that recorded voice messages are converted to text, for example. A voice mail mode, for example, may be turned “on” to indicate a speech-to-text conversion option.

Referring to FIG. 4, in one embodiment, SMSC 110 submits a view voice mail mode request to MSC 130 to determine if terminating device 170's configuration is set for speech-to-text conversion option. MSC 130 in turn makes an inquiry by communicating with terminating device 170. Terminating device 170 may respond by way of an acknowledgment. If terminating device 170 acknowledges that the view voice mail mode is “on”, then MSC 130 forwards the acknowledgment to SMSC 110 to convert the voice mail message to a text message. In this embodiment, a speech-to-text conversion engine resides in SMSC 110, for example, to perform the conversion.

As shown, once the text is converted, a short messaging protocol is invoked to transmit the text as a short message, for example, to terminating device 170 by interrogating HLR 124 for routing information. The text message is then transmitted in real-time to MSC 130, when SMSC 110 invokes a delivery request. MSC 130 then notifies terminating device 170 of the pending text message. Thus, the subscriber may choose to view the received text message immediately, or at a later time.

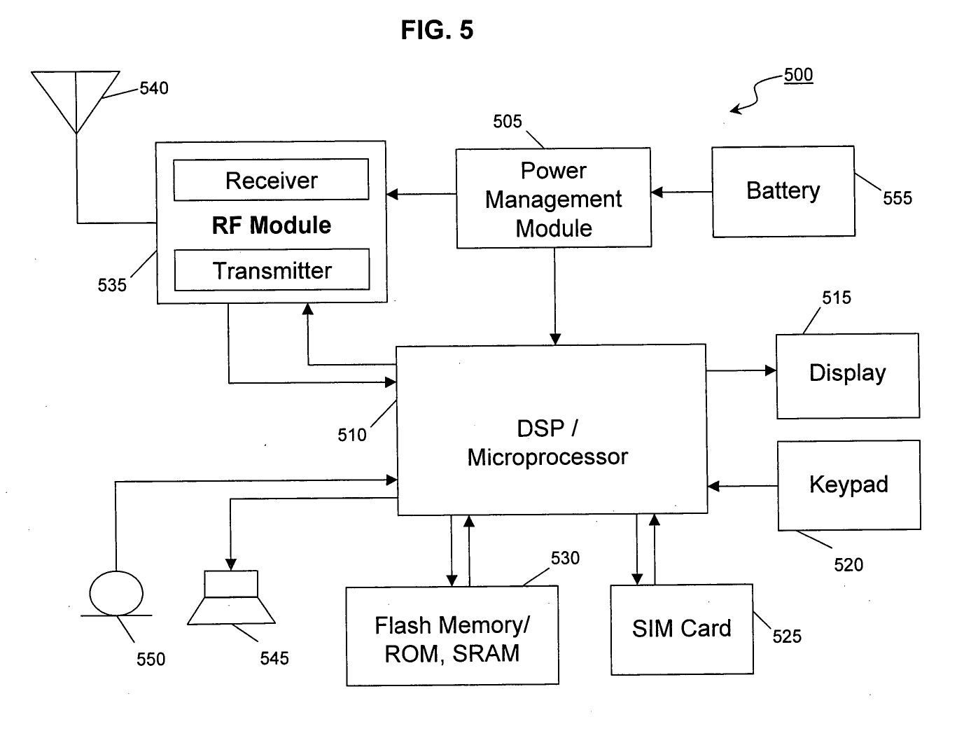

Referring to FIG. 5, the originating or terminating communications devices disclosed here in may be implemented in form of a mobile station 500. In a preferred embodiment, mobile station 500 comprises a processor (or digital signal processor) 510, RF module 535, power management module 505, antenna 540, battery 555, display 515, keypad 520, memory 530, SIM card 525 (which may be optional), speaker 545 and microphone 550.

A user enters instructional information, such as a telephone number, for example, by pushing the buttons of a keypad 520 or by voice activation using the microphone 550. The microprocessor 510 receives and processes the instructional information to perform the appropriate function, such as to dial the telephone number. Operational data may be retrieved from the Subscriber Identity Module (SIM) card 525 or the memory module 530 to perform the function. Furthermore, the processor 510 may display the instructional and operational information on the display 515 for the user's reference and convenience.

The processor 510 issues instructional information to the RF section 535, to initiate communication, for example, transmit radio signals comprising voice communication data. The RF section 535 comprises a receiver and a transmitter to receive and transmit radio signals. An antenna 540 facilitates the transmission and reception of radio signals. Upon receiving radio signals, the RF module 535 may forward and convert the signals to baseband frequency for processing by the processor 510. The processed signals would be transformed into audible or readable information outputted via the speaker 545, for example.

It will be apparent to one skilled in the art that the preferred embodiments of the present invention can be readily implemented using, for example, the processor 510 or other data or digital processing device, either alone or in combination with external support logic.

Preferred embodiments of the invention may be also implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). The code in the computer readable medium is accessed and executed by a processor.

The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. The logic implementation shown in the figures describes specific operations as occurring in a particular order. In alternative implementations, certain of the logic operations may be performed in a different order, modified or removed and still implement preferred embodiments of the present invention. Moreover, steps may be added to the above described logic and still conform to implementations of the invention.

Preferred embodiments of the invention are disclosed in association with mobile communication devices, such as cellular phones. In alternative embodiments, desktop and portable computers, PDA devices, and pagers can be alternative embodiments of the mobile communication devices disclosed herein.

The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein. These and various other adaptations and combinations of features of the embodiments disclosed are within the scope of the invention. The invention is defined by the claims and their full scope of equivalents.

1. A method of communicating data in a mobile communications network, the method comprising:
recording a voice message for delivery from an initiating device to a terminating device, wherein the initiating device and terminating device are configured to communicate over the mobile communications network;
converting the recorded voice message to a text message using a speech-to-text conversion process; and
delivering the text message to the terminating device by way of a text messaging service implemented over the mobile communications network for delivering text messages from the initiating device to the terminating device.

2. The method of claim 1, wherein the speech-to-text conversion process resides in the initiating device to convert the voice message to the text message.

3. The method of claim 1, wherein the speech-to-text conversion process resides in the mobile communications network to convert the voice message to the text message.

4. The method of claim 1, wherein the text messaging service is a short messaging service (SMS).

5. The method of claim 1, wherein the text messaging service is an extended messaging service (EMS).

6. The method of claim 1, wherein the text messaging service is a multi-media messaging service (MMS).

7. The method of claim 1, wherein a message mode is defined to indicate that the voice message should be converted to a text message.

8. The method of claim 7, wherein the message mode is set by a party using the initiating device.

9. The method of claim 7, wherein the message mode is set by a party using the terminating device.

10. The method of claim 1, wherein the recorded voice message is deleted after the text messaged is delivered to the terminating device.

11. A method of communicating data in a mobile communications network, the method comprising:
recording a voice message for delivery from an initiating device to a terminating device, wherein the initiating device and the terminating device are configured to communicate over the mobile communications network;
delivering the voice message to the terminating device over the mobile communications network; and
converting the recorded voice message to a text message using a speech-to-text conversion process residing on the terminating device.

12. The method of claim 11 further comprising displaying the text message on the terminating device.

13. The method of claim 11 further comprising delivering the text message from the terminating device to the terminating device using a text messaging service.

14. The method of claim 13, wherein the text messaging service is a short messaging service (SMS).

15. The method of claim 13, wherein the text messaging service is an extended messaging service (EMS).

16. The method of claim 13, wherein the text messaging service is a multi-media messaging service (MMS).

17. A communications device comprising:
means for interfacing with a voice recording mechanism to record a voice message for transmission to a first mobile device connected to a mobile communications network; and
means for choosing for the voice message to be converted to a text message via a speech-to-text conversion process, wherein the text message is delivered to the first mobile device by way of a text messaging service implemented over the mobile communications network.

18. The communications device of claim 17, wherein the text messaging service is a short messaging service (SMS).

19. The communications device of claim 17, wherein the text messaging service is an extended messaging service (EMS).

20. The communications device of claim 17, wherein the text messaging service is a multi-media messaging service (MMS).

21. A mobile device configured for communicating voice data over a mobile communications network, the mobile device comprising:
a microphone for receiving voice data to be transmitted to a target mobile device over the mobile communications network;
a speech-to-text converter for converting the voice data to text data; and
a text messaging mechanism for transmitting the text data over the mobile communications network to the target mobile device.

22. The mobile device of claim 21, wherein the text messaging service is a short messaging service (SMS).

23. The mobile device of claim 21, wherein the text messaging service is an extended messaging service (EMS).

24. The mobile device of claim 21, wherein the text messaging service is a multi-media messaging service (MMS).

25. A first mobile device configured for communicating data over a mobile communications network, the mobile device comprising:
a receiver for receiving voice data transmitted over the mobile communications network;
a speech-to-text converter for converting the voice data to text data; and
a text messaging interface for communicating the text data to a target mobile device over the mobile communications network.

26. The mobile device of claim 25, wherein the first mobile device is the target mobile device.
